(19) United States
(12) Patent Application Publication
(10) Pub. No.: US 2018/0018742 A1
(43) Pub. Date: Jan. 18, 2018

(54) MATCHING BY COMMITTEE

(71) Applicant: MEDDLE GROUP INC., SEATTLE, WA (US)

(72) Inventors: PETER LEONARD, SEATTLE, WA (US); CALEY ANDERSON, VASHON, WA (US)

(21) Appl. No.: 15/648,212

(22) Filed: Jul. 12, 2017

Related U.S. Application Data
(60) Provisional application No. 62/362,726, filed on Jul. 15, 2016.

(51) Int. Cl. G06Q 50/00; G07C 13/00

(52) U.S. Cl. CPC G06Q 50/01; G07C 13/00

(57) ABSTRACT

A system matches a user to one or more candidates. In particular, the user selects a plurality of advisors. The system identifies candidates based on criteria set by the user. The advisors then vote on the candidates. If the number of votes in favor of a candidate meets a selected threshold number of votes, then the user is notified that a match has been made.

### CROSS REFERENCE TO RELATED APPLICATION

The present application claims priority benefit from U.S. Provisional Patent Application No.62/362,726, entitled “MATCHING BY COMMITTEE,” filed Jul. 15, 2016 (docket number 3035-001-02); which, to the extent not inconsistent with the disclosure herein, is incorporated by reference.

### SUMMARY

In one embodiment, a system matches a user to one or more candidate individuals, products, or services. The user selects a plurality of advisors. The system identifies candidates based on criteria set by the user. The system provides information to the advisors regarding the candidates. The advisors then vote on the candidates. If the number of votes in favor of a candidate meets a selected threshold number of votes, then the user is notified that a match has been made.

### BRIEF DESCRIPTION OF THE DRAWINGS

FIG. 1 is a block diagram of software architecture for matching a user to one or more candidates, according to an embodiment.

FIG. 2 is a block diagram of a process for matching a user to one or more candidates, according to an embodiment.

FIG. 3 is a flow diagram of a process for matching a user to one or more candidates, according to an embodiment.

FIGS. 4-8 are diagrams of various screens of a GUI associated with a system for matching user to one or more candidates, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In one embodiment, matches are formed based on a minimum threshold of votes by selected agents.

Daters, shoppers, etc. (“Users”) determine certain search criteria for the people, places, or things they're looking for (“Candidates”). The Users select agents (“Advisors”) to help form matches. There is a minimum number (“Threshold”) of Advisor votes required for a match to take place, ranging from 1 to the number of Advisors each User has invited. The Threshold may be determined by the User or may be a pre-set number.

Each Advisor views each Candidate that qualifies for the User's criteria and votes on whether or not it is a fit for the User. If deemed a fit, an Advisor indicates approval (votes “Yes”). If deemed to not be a fit, the Advisor indicates disapproval (votes “No”). Once the Threshold of votes is met or exceeded, a match is formed on the User's side. If the Threshold is not reached, no match is formed.

In some cases, e.g. online dating, the Threshold in favor of the match would need to be reached on the Candidate's side as well, in order for a Mutual Match to occur. If a Mutual Match occurs, the User and Candidate are both notified of the Match and a line of communication is opened.

In other cases, e.g. shopping, where a Threshold of votes may not be required from the Candidate's side, the User is notified when a match occurs. The User may then proceed with a subsequent action (e.g. purchase) if desired.

Matchmaking Sites

SparkStarter

Spritzr

Hitch

Dating Sites

Match

OkCupid

Tinder

E-Harmony

Rating Sites

Yelp

Amazon

Netflix

TripAdvisor

“Matching by Committee” is unique in that the User does not match with eligible Candidates until the Candidates meet a Threshold of the User's Advisors' votes. Each Advisor gets a vote to determine whether or not a Match between the User and Candidate is advisable. If the number of votes meets or exceeds the approval Threshold, a Match is formed between the User and the Candidate.

The Threshold component is one of the aspects of one embodiment of Meddle that differentiates Meddle from traditional dating sites such as Match and E-Harmony, where third party agents are not used to create matches, as well as matchmaking sites such as SparkStarter and Spritzr, where the User is notified each time one of their third party agents recommends a match. Spritzr also allows recommendations from a community of agents that the User has not invited. Another app, called Hitch, limits its Candidates to the third party agents' friends.

Many sites (Amazon, Yelp, Netflix, TripAdvisor, etc.) show ratings that users give (e.g., on a scale of 1-5). You can see all reviews, whether good or bad. “Matching by Committee” takes a different approach by only showing a User the Candidates (potential dates, products, etc.) that are determined to be “good enough” by the User.

What makes a Candidate “good enough” is having enough “Yes” votes by the User's Advisors to meet or exceed the User's required Threshold of “Yes” votes. Compared with Amazon and the other sites with product ratings, one embodiment of Meddle is different in that it lets Users select the people whose advice they value and trust, making the matches more personalized and relevant. This is meant to help the User cut through what can be an overwhelming amount of qualitative information and get to better choices through the help of trusted advisors.

“Matching by Committee” could also be used if the User would like to implement a “No” Threshold as well. For example, if a User would like to ask his or her Advisors, “Should I buy this widget?”, a reply could come back if the Threshold for “Yes” is met, but also if a Threshold for “No” is met. The User would then know to not buy that specific widget. The same matching mechanism described for the “Yes” Threshold also applies for the “No” Threshold.

Ways to Invite Advisors

Email

Text

Whatsapp

Social Media (Facebook, LinkedIn, Twitter, SnapChat, etc.)

Voting Methods

Swiping

Selecting “Yes” or “No”

Rating

The invention is herein described, by way of example only, with reference to the accompanying drawings, wherein:

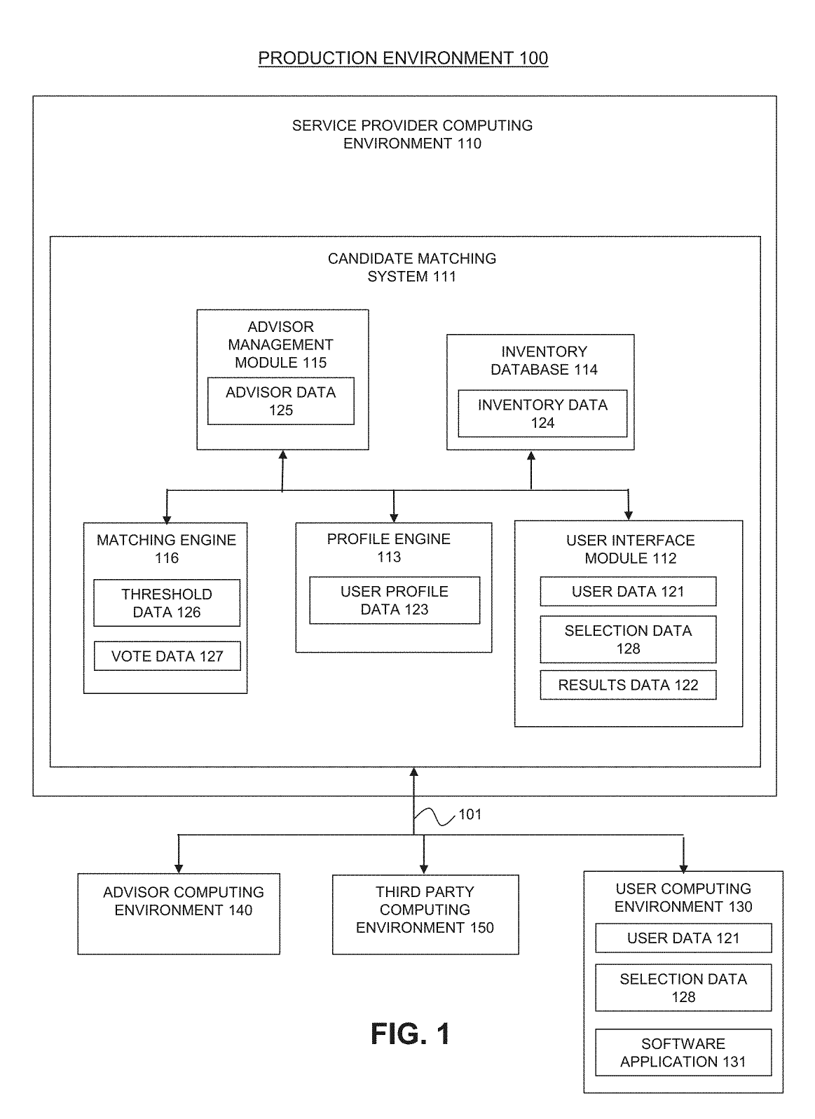

FIG. 1 is a block diagram of software architecture for matching the user to one or more candidates, according to one embodiment.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system,” “computing device,” and “computing entity,” include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “relationship(s)” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed form-fill assistance system determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

FIG. 1 is a block diagram of a production environment 100 for matching a user to one or more candidates, according to one embodiment. Embodiments of the present disclosure provide methods and systems for matching a user to one or more candidates, according to one embodiment.

The production environment 100 includes a service provider computing environment 110, a user computing environment 130, an advisor computing environment 140, and a third party computing environment 150. The computing environments 110, 130, 140, and 150 are communicatively coupled to each other with one or more communication channels 101, according to one embodiment.

The service provider computing environment 110 represents one or more computing systems such as a server, a computing cabinet, and/or distribution center that is configured to receive, execute, and host one or more candidate matching systems, according to one embodiment. The service provider computing environment 110 represents a traditional data center computing environment, a virtual asset computing environment (e.g., a cloud computing environment), or a hybrid between a traditional data center computing environment and a virtual asset computing environment, according to one embodiment.

The service provider computing environment 110 includes a candidate matching system 111, which is configured to provide efficient data searches.

The candidate matching system 111 includes a user interface module 112, a profile engine 113, an inventory database 114, an advisor management module 115, and a matching engine 116.

The user interface module 112 enables a user to interface with the candidate matching system 111. The user interface module 112 receives user data 121 from the user. The user data 121 can include data regarding personal attributes and preferences of the user. The user data 121 can include data such as a name of the user, an age of the user, a gender of the user, a marital status of the user, an address of the user, a relationship status of the user, a birthday of the user, an education profile of the user, an employment situation of the user, whether or not the user has children, details regarding previous relationships of the user, an income of the user, or any other personal information related to the user. The user data 121 can further include preferences of the user with regards to characteristics of the candidate to which the user would like the matched. The candidate can include a product, a person, a service, or another type of candidate to which the user would like to be matched. The user data 121 can therefore include data related to preferences of the user with regards to products, services, people, or other types of candidates to which the user could be matched.

According to an embodiment, the profile engine 113 receives the user data 121 from the user interface module 112. The profile engine 113 generates user profile data 123 that indicates the profile of the user, based on the user data 121 and other data retrieved by the system 111.

According to an embodiment, the inventory database 114 includes inventory data 124. The inventory data 124 can include data related to potential candidates to which the user could be matched. For example, the inventory data 124 can include data related to potential people to which the user can be matched. Additionally or alternatively, the inventory data 124 can include data related to potential products or services to which the user can be matched. The inventory data can include personal characteristics of other people, characteristics or specifications of products or services, or other types of characteristics that can be useful in selecting a potential match for user.

The candidate matching system 111 enables the user to select advisors to assist in matching the user to a candidate. The advisors can review the user profile data 123 and the inventory data 124 in order to find candidates to which the user can be matched. The advisors can vote for or against a match to a potential candidate. If the number of votes in favor of a candidate as represented in the inventory data 124 exceeds or matches a threshold number of votes, then the user is matched to the potential candidate. The user can then be informed of the match and can take further action such as purchasing the candidate product or service or contacting or agreeing to contact a candidate person. For this reason, the user interface module 112 receives selection data 128 from the user. The selection data 128 indicates one or more advisors that the user wishes to assist in matching him or her to candidate people, products, or services. The user interface module 112 passes the selection data 128 to the advisor management module 115.

The advisor management module 115 stores advisor data 125 related to the advisors selected by the user. Additionally or alternatively, the advisor data 125 can include data related to a list of advisors from which the user can select one or more advisors. When the user selects advisors to assist in matching the user to a candidate, the advisor management module 115 stores advisor data 125 related to the selection. The advisor management module 115 can contact the advisors selected by the user to inform them that the user has selected them as advisors. The advisors can agree to assist the user. The advisor management module 115 can contact the advisors by email, by phone, by text message, by social media applications, or in any other suitable way. Additionally or alternatively, the user can contact the selected advisors directly.

The matching engine 116 includes threshold data 126. The threshold data 126 indicates a threshold number of votes or a threshold percentage of votes in favor of a candidate that must be received in order for the user to be matched to the candidate. The threshold can be selected by the user and/or the advisors, and/or the matching engine 116. The matching engine 116 receives vote data 127 from the advisors. The matching engine 116 can also receive a vote from the user. If the number of votes in favor of a particular candidate exceeds the threshold number, threshold percentage, or threshold proportion of votes then the matching engine 116 matches the user to the candidate.

According to an embodiment, the threshold number of positive advisor responses includes a majority of the plurality of advisors. For example, according to an embodiment the threshold number of positive advisor responses includes at least 62% of the plurality of advisors. According to another embodiment, the threshold number of positive advisor responses includes fewer than a majority of the plurality of advisors.

The matching engine 116 communicates with the advisors by communicating with the advisor computing environment 140. The advisor computing environment 140 can include several distinct computing environments each associated with a respective advisor. The advisor computing environment 140 can include one or more personal computers, tablet computers, smart devices, or other types of computing devices by which the advisors can communicate with the candidate matching system 111 and/or with the user computing environment 130.

The user computing environment 130 can likewise include one or more personal computers, tablet computers, smart phones, smart devices, smart watches, or other types of computing devices by which a user can communicate with the candidate matching system 111 and/or the advisor computing environment 140. The user computing environment 130 can include the software application 131. The software application 131 includes software associated with the candidate matching system 111. The software application 131 can be provided to the user computing environment 130 by the candidate matching system 111. The software application 131 can allow the user to interface with the candidate matching system 111. Additionally or alternatively, the software application 131 can include one or more of the modules, databases, and engines shown as part of the candidate matching system 111 in FIG. 1. Therefore, the candidate matching system 111 can be wholly or partially implemented in the user computing environment 130.

In one example, the candidate matching system 111 is a system that assists in matching the user to one or more candidate individuals as part of a dating service, a matchmaking service, or a meetup service. The user submits user data 121 that indicates what the user's personal characteristics are and what the user's personal preferences are for candidate individual. The user also provides selection data 128 that indicate one or more advisors from the user would like to assist in matching the user to a candidate individual. The selection data 128 can also include threshold data 126 indicating the number or proportion of votes in favor of a candidate that should be received in order for a match to occur.

The matching engine 116 analyzes the inventory data 124 and selects candidates that meet the user's criteria. The matching engine 116 communicates with the advisors and invites them to view the inventory data 124 related to the candidates identified by the matching engine 116. The inventory data 124 can include photographs of the candidate individuals and other characteristics of the candidate individuals. The advisors can cast a vote for or against a match with each of the candidates. If a candidate receives enough votes to satisfy the threshold data 126, then a match is made. The user interface module 112 outputs results data 122 to the user computing environment 130. The results data 122 indicates one or more matches based on the votes of the advisors. The results data 122 can invite the user to act on the matches, for instance by initiating communication with the matched individuals. In one embodiment, the matching engine 116 can also communicate with the matched individuals to indicate a match has been made. In one embodiment, the user can review the inventory data 124 related to the matched candidates in order to accept or reject the match.

In one embodiment, it is the advisors that select the candidates from the inventory data 124. The advisors can vote on the selected candidates. Additionally or alternatively, the user can select candidates from the inventory data 124. The advisors can then review the selected candidates and vote as described previously. If the votes satisfy the threshold data 126, then the user is informed that a match has been made.

In one embodiment, the candidate matching system 111 assists in matching the user to products or services that the user can purchase. For example, the user data 121 can include criteria for the product or service that the user would like to purchase. The matching engine 116 can review the inventory data 124 to find one or more products that meet the criteria provided by the user. The matching engine 116 can then request the advisors to review the inventory data related to the candidate products or services. The advisors can then vote on the candidate products or services. If the candidate product or service receives enough votes to satisfy the threshold data 126, then the matching engine 116 identifies a match. The user interface module 112 then outputs results data 122 to the user indicating the match. The user then has the option of acting on the results data to purchase or otherwise access the matched products or services.

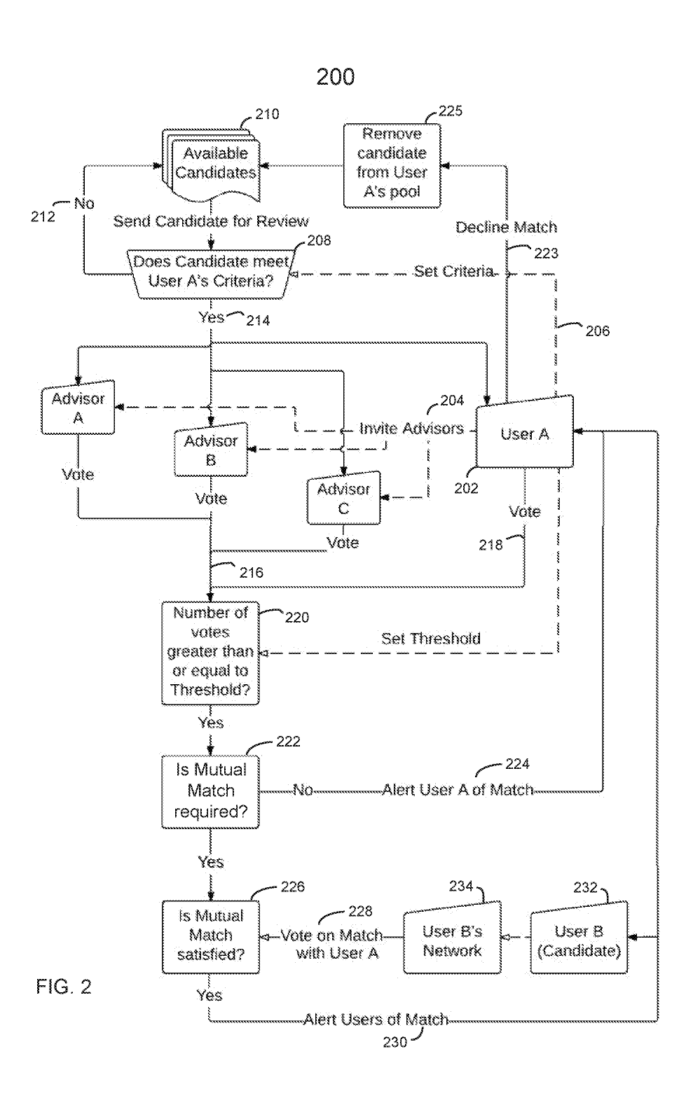

FIG. 2 is a flow diagram of a method for determining whether or not a Match should occur between a User and a Candidate.

User A (1) sets Criteria, (2) selects Advisors, and (3) sets Threshold.

(1) The Criteria is used to filter down the pool of all possible Candidates into a subset of Candidates closer to what the User is looking for.

(2) The Advisors are chosen by the User and act as agents who can vote on the Candidates for the User.

(3) The Threshold is the minimum number of votes required by the User to determine a Match. It can range in number between 1 and the total number of the User's Advisors.

If a Candidate meets User A's Criteria, each Advisor can then view the Candidate.

Each Advisor then independently votes on whether or not a Match should occur between User A and the Candidate.

User A can also vote on the Candidate. If at any time during the process User A votes “No” or declines the Match, that Candidate is removed from User A's pool of potential Candidates and is not viewable by the User's Advisors after that.

If the number of votes from User A's Network (Advisors+User A) meets or exceeds User A's Threshold, a Match is formed on User A's side. If the Threshold is not met, the Candidate remains in User A's pool of potential Candidates for Advisors to vote on, unless the User has declined the Match.

If a Mutual Match is not required (e.g. in the case of shopping), User A is notified when the Match occurs and can proceed with a subsequent action (e.g. purchase).

If a Mutual Match is required (e.g. in the case of dating), the system checks the Candidate's (User B's) Network to see if User B's Threshold has been met. If a Mutual Match has occurred (User A's Threshold and User B's Threshold have each been satisfied) then both Users are notified of the Match and can proceed with a subsequent action (e.g. messaging each other). Neither User is notified until a Mutual Match occurs.

At 204, user A invites Advisors A, B, and C to assist the user in being matched to another candidate individual. At 206, the user provides selection criteria indicating the type of individual or the characteristics of the individual to which the user would like to be matched. At 208 the candidate matching system determines from a list 210 of available candidates whether a candidate meets the criteria set by the user. If no, then at 212, another available candidate is selected for review. If the candidate meets the criteria, then at 214, the advisors are invited to vote on the candidate. The advisors review the information related to the candidate and vote at 216. At 218 the user also can vote. At 220, the votes are counted to determine if the votes satisfy the threshold vote number. If the number of votes satisfies the threshold, then at 222 it is determined whether a mutual match is required. In other words it is determined whether the advisors of the matched candidate must also determine that user A is a match for the matched candidate. If a mutual match is not required, then at 224 user A is alerted that a match has been made. At 223, user A can decline the match. If the user A declines the match, then at 225 the matched candidate is removed from the pool of available candidates 210. If a mutual match is required, then at 226 it is determined whether a mutual match has been satisfied. For instance, at 234, user B's network of advisors votes on user A. If user B's advisors vote yes on user A at 228, then at 230 both user A and the matched candidate, user B, are notified of the match.

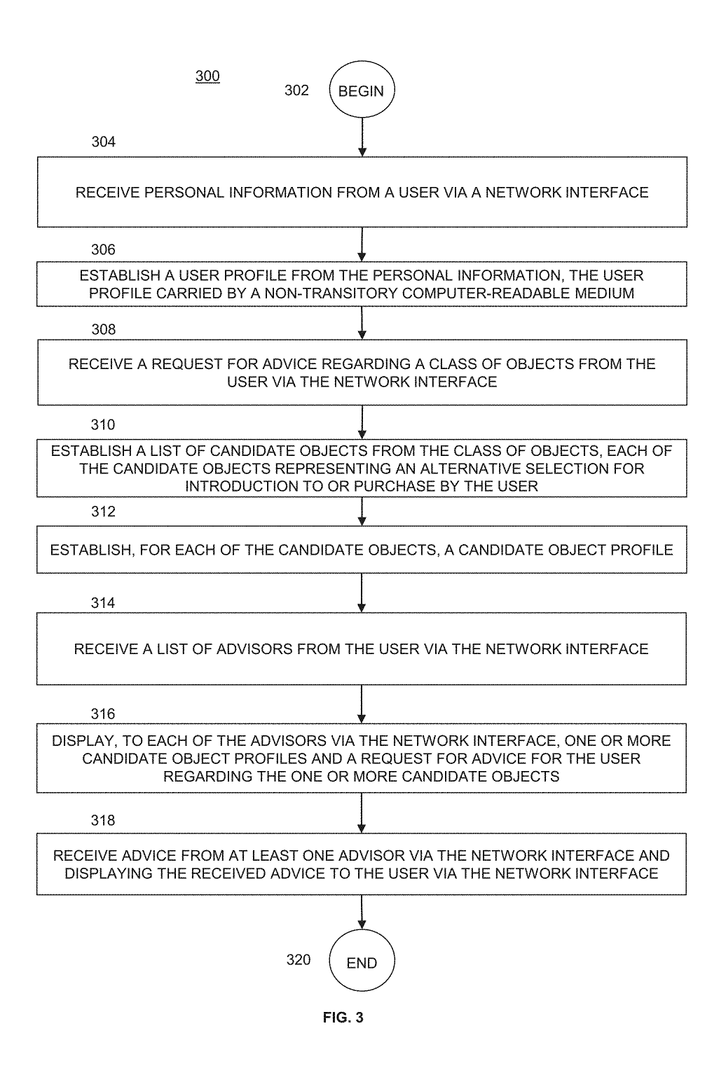

FIG. 3 is a flow diagram of a process 300 for matching a user to one or more candidates, according to an embodiment.

At 302 the process begins, according to an embodiment.

At 304 personal information is received from a user via a network interface, according to an embodiment.

At 306 a user profiles established from the personal information, the user profile carried by a non-transitory computer readable medium, according to an embodiment.

At 308 a request is received for advice regarding a class of objects from the user via the network interface, according to one embodiment.

At 310 a list of candidate objects is established from the class of objects, each of the candidate objects representing an alternative selection for introduction to or purchased by the user, according to an embodiment.

At 312, for each of the candidate objects a candidate object profile is established, according to an embodiment.

At 314, a list of advisors is received from the user via the network interface, according to an embodiment.

At 316 one or more candidate object profiles and request for advice for the user regarding one or more candidate objects is displayed to each of the advisors via a network interface, according to an embodiment.

At 318 advice from at least one advisor is received via a network interface and displayed to the user via a network interface, according to an embodiment.

At 320 the process ends, according to one embodiment.

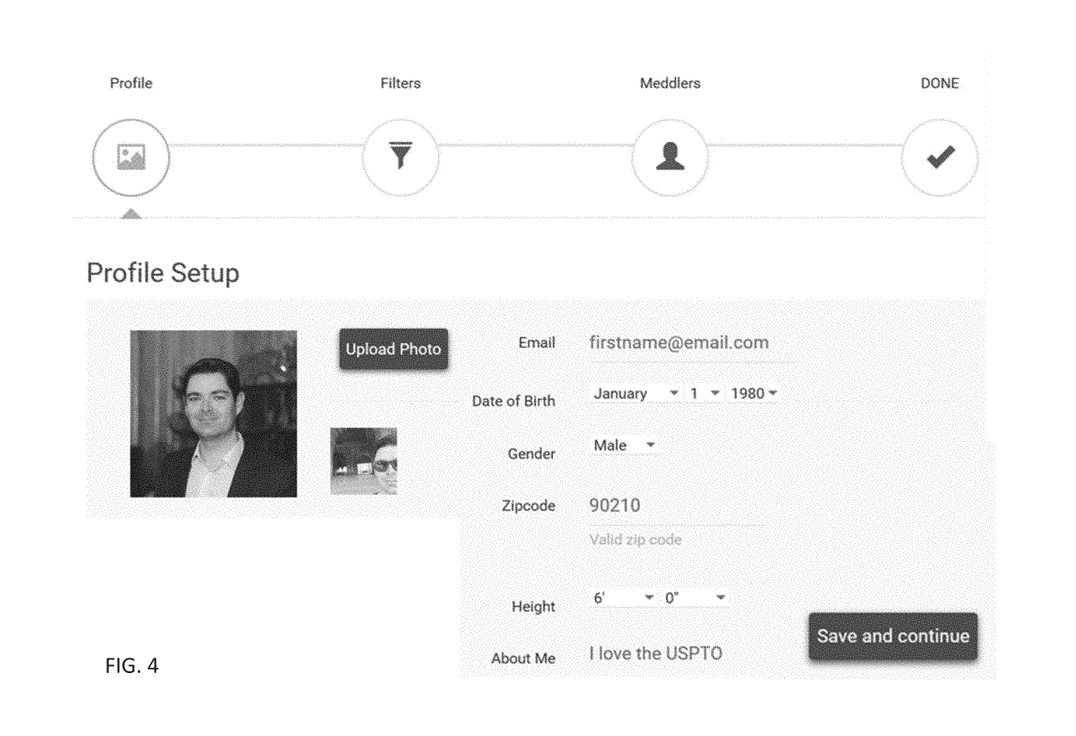

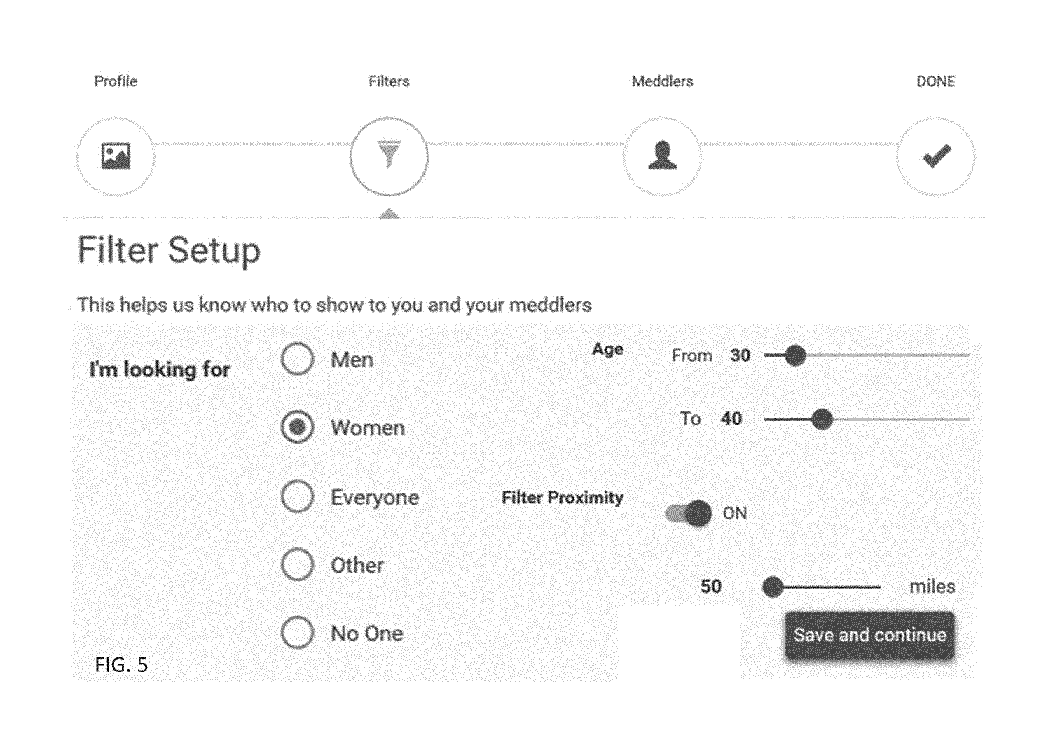

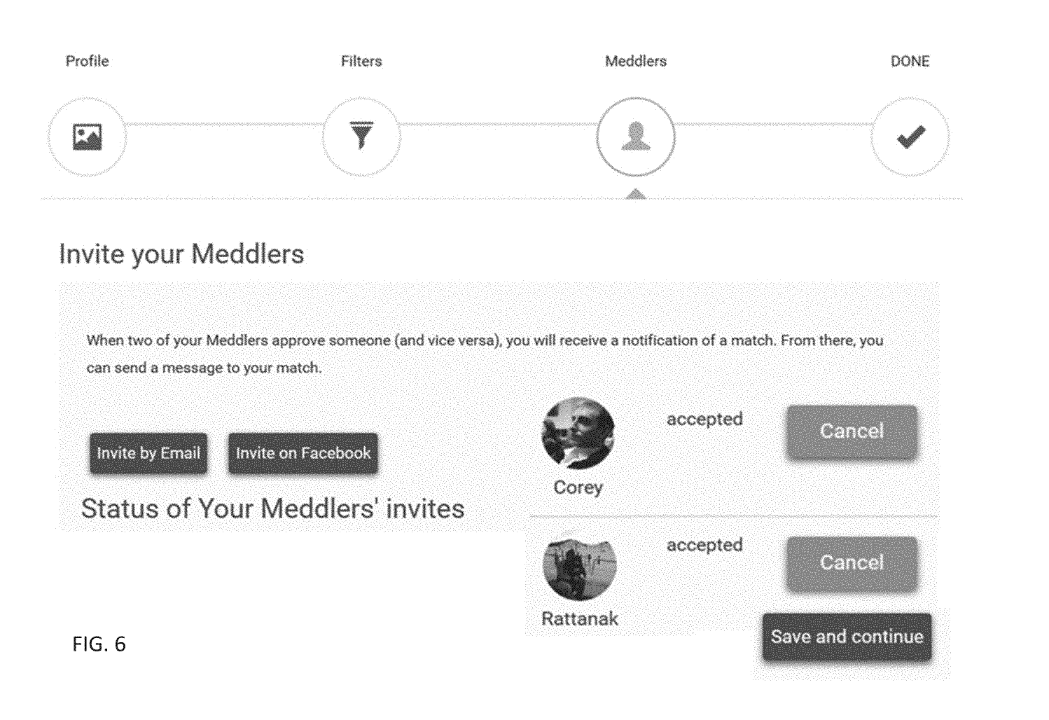

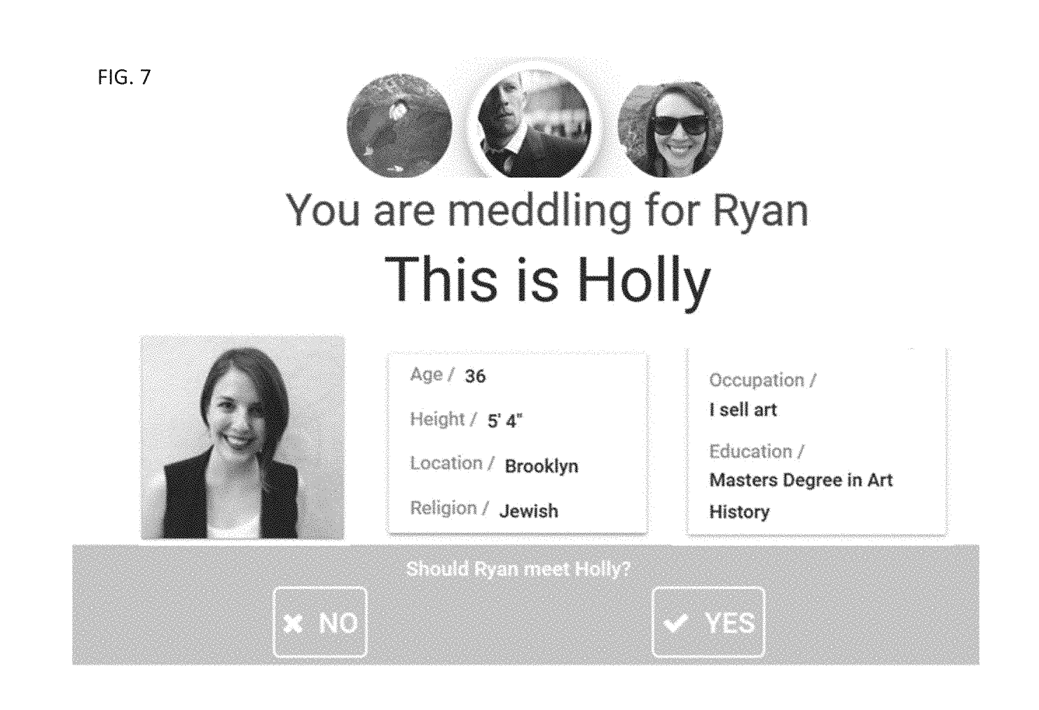

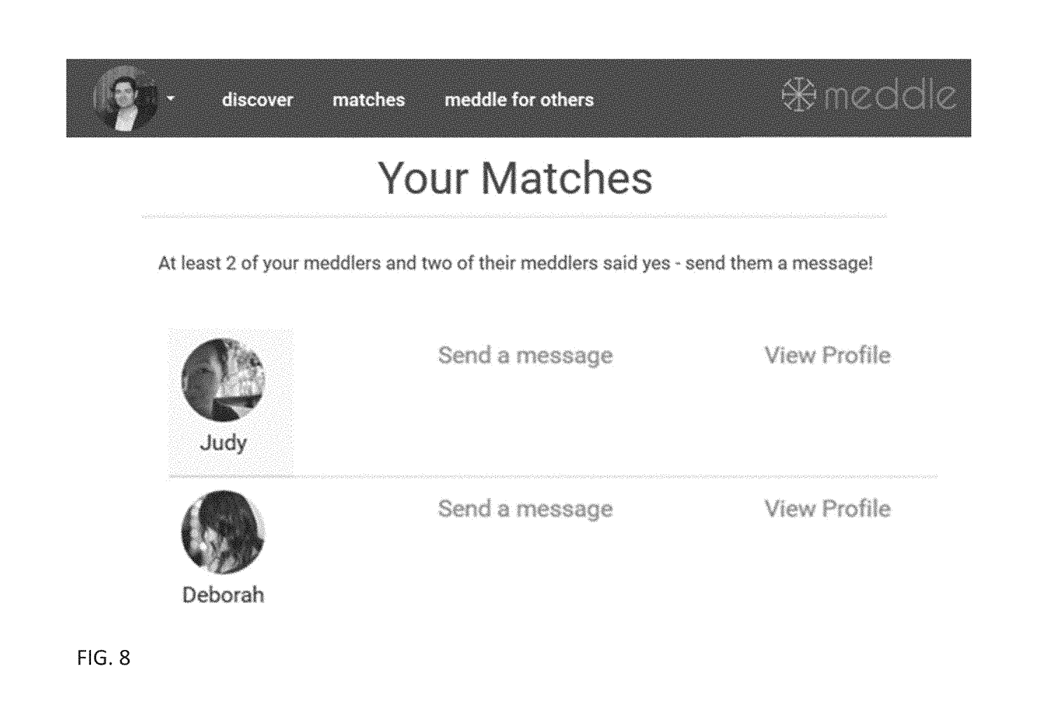

FIGS. 4-8 are diagrams of various screens of a GUI associated with a system for matching user to one or more candidates, according to an embodiment.

Embodiments described herein provide a computer apparatus, computer software, and computer method that provide advisor feedback to populate a user GUI for providing selection advice for a range of objectives. Requests for advice are automated and simplified to reduce message latency, and multiple responses are aggregated to reduce a number of messages transmitted across a system. According to embodiments, this results in reduced server processing and storage requirements per transaction to improve the speed or capacity of the server.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A computer server method for obtaining advice, comprising:
receiving personal information from a user via a network interface;
establishing a user profile from the personal information, the user profile carried by a non-transitory computer-readable medium;
receiving a request for advice regarding a class of objects from the user via the network interface;
establishing a list of candidate objects from the class of objects, each of the candidate objects representing an alternative selection for introduction to or purchase by the user;
establishing, for each of the candidate objects, a candidate object profile;
receiving a list of advisors from the user via the network interface;
displaying, to each of the advisors via the network interface, one or more candidate object profiles and a request for advice for the user regarding the one or more candidate objects;
receiving advice from at least one advisor via the network interface; and
displaying, to the user via the network interface, the received advice.

2. The computer server method of claim 1, wherein the list of advisors includes a plurality of advisors; and
wherein receiving advice from at least one advisor includes receiving advice from the plurality of advisors.

3. The computer server method of claim 2, further comprising:
establishing a threshold number of positive advisor responses;
wherein receiving advice from at least one advisor comprises receiving a plurality of positive advisor responses at least equal to the threshold; and
wherein displaying the received advice comprises displaying one or more particular candidate objects that receive positive advisor responses at least equal to the threshold, and not displaying any particular candidate object that does not receive positive advisor responses at least equal to the threshold.

4. The computer server method of claim 3, wherein the threshold number of positive advisor responses comprises a majority of the plurality of advisors.

5. The computer server method of claim 4, wherein the threshold number of positive advisor responses comprises at least 62% of the plurality of advisors.

6. The computer server method of claim 3, wherein the threshold number of advisor responses comprises fewer than a majority of the plurality of advisors.
